(19) United States
(12) Patent Application Publication
(10) Pub. No.: US 2011/0036510 A1
(43) Pub. Date: Feb. 17, 2011

(54) MAGNETIC DRIVING DEVICE AND BUILT-IN SUNSHADE PRODUCTS ADAPTED FOR USE IN DOUBLE GLAZING

(76) Inventor: Renzhe JIN, Qinhuangdao (CN)

Correspondence Address: PILLSBURY WINTHROP SHAW PITTMAN, LLP, P.O. BOX 10500, MCLEAN, VA, 22102, US

(21) Appl. No.: 12/834,489

(22) Filed: Jul. 12, 2010

(30) Foreign Application Priority Data
Aug. 14, 2009 (CN) 200910168215.3

(51) Int. Cl. H01F 7/02; E06B 9/24

(52) U.S. Cl. 160/19; 335/229

(57) ABSTRACT

A magnetic driving device comprises a slider disposed on an inside of a glass; a handle disposed on an outside of the glass; a plurality of magnets respectively disposed in the slider and the handle, the polarities of the adjacent magnetic poles of the magnets disposed in the slider being opposite to each other, the polarities of the adjacent magnetic poles of the magnets disposed in the handle being opposite to each other; and a spacing layer disposed between the adjacent magnets to space the adjacent magnets from each other, the spacing layer being made of a material that is not a magnet, wherein positions of the magnets in the slider and positions of the magnets in the handle correspond to each other one by one, and the polarities of the magnetic poles, which are toward the glass, of the magnets in the slider are opposite to the polarities of the magnetic poles, which are towards the glass, of the corresponding magnets in the handle, respectively.

### BACKGROUND OF THE INVENTION

1. Field of the Invention

The present invention relates to a magnetic driving device and particularly to a magnetic driving device mounted on both sides of a glass. The present inventive also relates to a built-in sunshade product with the magnetic driving device for use in a double glazing.

2. Description of the Related Art

For demands of environmental protection, energy saving and comfortable living, sunshade products are broadly used. A blind (curtain) and a foldable curtain are commonly used on indoor windows. With more than one hundred year's development, double glazing has been widely used throughout the world due to its special characteristics such as thermal insulating property, sound proof property, frost proof property, and dust and pollution proof property. Chinese patents applications ZL03238471.8 (patent family in US is U.S. Pat. No. 7,124,803B2), ZL200320128533.5, ZL200420057384.2 and so on filed by the same applicant as the present invention relate to the blind built within the double glazing, which belongs to one of built-in sunshade products for the double glazing. The blind within the double glazing is designed to be operated by a magnetic driving device.

FIGS. 1A and 1B are schematic views showing a configuration of an existing magnetic driving device, and FIG. 1C is a schematic side view showing the configuration of the existing magnetic driving device. As shown in FIGS. 1A and 1B, a double glazing with a blind is composed of supporting members 24, 25, an outdoor-side glass 23, an indoor-side glass 23A, and a plurality of slats 21. As shown in FIGS. 1A and 1B, the double glazing with the blind further includes a slat-turning pull rope 7, an elevating ropes 10, 12, ladder ropes 3, 5, and a weight bottom member 20.

As shown in FIG. 1C, a slat-turning operating handle 51 and a slat-turning slider 26 are disposed on an outside and an inside of the indoor-side glass 23A, respectively. An elevating operating handle 52 and an elevating slider 13 are disposed on the outside and the inside of the indoor-side glass 23A, respectively. Magnets 15A and 15B are disposed in the slat-turning operating handle 51 and the elevating operating handle 52, and the slat-turning slider 26 and the elevating slider 13, respectively. The magnets 15A and 15B attracts each other with magnetic line of force passing through the glass. The slat-turning operating handle 51 and the elevating operating handle 52 are respectively operated to move upwards and downwards so that the moving magnets 15A move the magnets 15B under the action of magnetic force. As a result, the slat-turning pull rope 7, or the elevating ropes 10, 12 are conveniently driven to perform operations such as elevation, opening, and closing and the likes of the blind. Their operation principles are the common knowledge and are not described herein.

However, the above well-known technique has the following disadvantages. Specifically, when a heavy blind is used or the operation handles are moved quickly, the sliders and the operating handles probably fall from each other.

FIGS. 2A-2D are schematic views showing operation and fall of the magnetic driving device.

FIG. 2A is the schematic view showing a state of the magnets located on the outside and inside of the glass without external force. The slat-turning operating handle 51 and the slat-turning slider 26 are described as an example. The magnet 15A in the slat-turning operating handle 51 comprises magnets 151A, 152A and 153A. The polarities of the adjacent magnetic poles of the magnets 151A, 152A and 153A are opposite to each other. The magnet 15B in the slat-turning slider 26 comprises magnets 151B, 152B and 153B. The polarities of the adjacent magnetic poles of the magnets 151B, 152B and 153B are opposite to each other. As shown in FIG. 2A, a position of the magnet 151A corresponds to a position of the magnets 151B, a position of the magnet 152A corresponds to a position of the magnet 152B, and a position of the magnet 153A corresponds to a position of the magnet 153B. The polarities of the magnetic poles, which face each other, of the magnet 151A and the magnet 151B are opposite to each other, the polarities of the magnetic poles, which face each other, of the magnet 152A and the magnet 152B are opposite to each other, and the polarities of the magnetic poles, which face each other, of the magnet 153A and the magnet 153B are opposite to each other. The magnets 15A and 15B attract each other to be positioned on both sides of the glass. An attractive force between the magnets 15A and 15B are perpendicular to a surface of the glass. The magnets 15A and 15B are substantially aligned with each other.

FIG. 2B is the schematic view showing a state of the magnets located on the outside and inside of the glass with a small external force F applied to the handle. As an example, the external force F is downward. As shown in FIG. 2B, when the external force F is acted on the magnet 15A, the magnet 15 will first move a small displacement H so that the magnet 15A offsets from the magnet 15B. As a result, the magnet 151A partly overlaps the magnet 152B, and the magnet 152A partly overlaps the magnet 153B.

When only taking the magnets 151 and 151B in consideration, a magnetic force which attracts them to approach each other is generated by the magnets 151 and 151B due to the offset. The magnet force can be equivalently discomposed into an attractive force perpendicular to the glass and a driving force F1 for driving the magnet 151B to move downwards. The driving force F1 is parallel to the surface of the glass and oriented in the same direction as the external force F. Meanwhile, since the slat-turning pull rope 7 is pulled by the weight of the slats 21 and a friction is generated between the magnet 151B and the glass, the magnet 151b is subjected to a pulling force in a direction opposite to that of the external force. The pulling force forms a resistance F2 to movement of the magnet 151B.

However, the magnet 151A partly overlaps the magnet 152B due to the offset. Since the polarities of the magnetic poles, which face each other, of the magnet 151A and the magnet 152B are the same, a repulsion force F3 is generated in a direction perpendicular to the surface of the glass. The repulsion force F3 counteracts the attractive force between the magnets 151A and 151B. In other words, the repulsion force F3 has an adverse effect on movement of the magnet 151B driven by the magnet 151A. A resultant attractive force is reduced. Attractive forces between magnets 152A and 152B and between magnets 153A and 153B are subjected to the similar adverse effect as the attractive force between the magnets 151A and 151B, and the corresponding description is not repeated.

When the driving force applied to the 15B by the magnet 15A is larger than the resistance to the magnet 15B, the magnet 15A can drive the magnet 15B to move.

FIG. 2C is the schematic view showing a state of the magnets located on the outside and inside of the glass with a large external force F applied to the handle. The driving force F1 is generated only when the magnets offset from each other, and with the increase of the offset, the driving force F1 will be increased in a certain range of offset. However, the increase of the offset will increase the repulsion force F3. If the slats 21 are heavy, a great external force F must be exerted to overcome the resistance F2. Sometimes the offset will be further increased due to inappropriate operation. When the relative offset reaches half of a thickness W1 of the single magnet, the attractive force applied to the magnet 151A by the magnet 151B and the repulsion force applied to the magnet 151 A by the magnet 152B are opposite in direction to each other and substantially the same in magnitude. Therefore, a resultant attractive force is nearly zero. The magnets 152A, 152B and 153B are subjected to the same situation as the above magnets.

At the same time, the attractive force applied to the magnet 153A by the magnet 153B is considerably reduced and the attractive force applied to the magnet 151B by the magnet 151A is considerably decreased.

In other words, a resultant attractive force between the magnets 15A and 15B is quickly reduced.

In actual operation, since the external force F is eccentrically applied, the slat-turning operating handle 51 and the slat-turning slider 26 begin to fall at the moment as shown in FIG. 2D. The magnetic drive fails.

The elevating operating handle 52 and the elevating slider 13 are subjected to the same situation as the above handle and slider.

### SUMMARY OF THE INVENTION

Accordingly, a main object of the present invention is to provide a magnetic driving device to effectively overcome the above defect, thereby decreasing or eradicating a repulsion force.

Both sides of a glass are respectively defined as an inside and an outside, which outside is the side of the glass on which a handle operated by a user is disposed, while which inside is the opposite side of the glass on which a slider is disposed, in the present invention for the purpose of convenient description.

In order to achieve the object, the present invention provides a magnetic driving device. The magnetic driving device comprises a slider disposed on an inside of a glass; a handle disposed on an outside of the glass; a plurality of magnets respectively disposed in the slider and the handle, the polarities of the adjacent magnetic poles of the magnets disposed in the slider being opposite to each other, the polarities of the adjacent magnetic poles of the magnets disposed in the handle being opposite to each other; and a spacing layer disposed between the adjacent magnets to space the adjacent magnets from each other, the spacing layer being made of a material that is not a magnet, wherein positions of the magnets in the slider and positions of the magnets in the handle correspond to each other one by one, and the polarities of the magnetic poles, which toward the glass, of the magnets in the slider are opposite to the polarities of the magnetic poles, which are towards the glass, of the corresponding magnets in the handle, respectively. The material comprises any of the materials other than magnet. The spacing layer is disposed so that when the magnets respectively disposed on the inside and outside of the glass offset from each other, the magnets will not face the other magnets that repulse them due to the same polarity of the facing magnetic poles, but will face the spacing layers of the material other than magnet. Therefore, the repulsion force will be decreased or eradicated.

Plastic material, stainless steel, brass, aluminum, iron or the like may be selected as the material of the spacing layer. Material that cannot be magnetized is preferable, for example, plastic material, or some kinds of stainless steels. The plastic material has a low specific gravity and thus is preferable. There are many kinds of stainless steels of which some kinds of stainless steels will be weakly magnetized and may be selected although their effect is bad. The iron can be magnetized, but a magnetic force of the magnetized iron is lower than that of a magnet. Therefore, the iron may be selected although its technical result is not good. The spacing layer may be made of a single material or a plurality of materials. The spacing layer may be formed in a hollow frame structure. Even if the frame is made of iron, the spacing layer will produce excellent effect. The spacing layer may be formed of nonmagnetic material.

Preferably, the corresponding magnets in the handle and the slider have the same thickness and the spacing layers have the same thickness to ensure that the repulsion force is minimized while the magnetic force is maximized.

According to an embodiment of the present invention, the thickness of the spacing layer may be larger than or equal to 2 mm. Since in actual operation, the offset distance between the magnets disposed in the handle and the slider can easily reach nearly 2 mm, the offset magnets will move beyond the spacing layers to produce the repulsion force with the facing magnets due to the same polarity of the magnetic poles thereof if too thin spacing layer is selected. Therefore, the spacing layer having a larger thickness is advantageous. However, too larger thickness is not necessary since it will increase the entire volume of the device.

It is found by test that when the offset reaches 30%-50% of the thickness of the magnet, a maximum driving force can be generated. Therefore, the thickness of the spacing layer may be less than the thickness of the magnet, and preferably, the thickness of the spacing layer is equal to 30%-50% of the thickness of the magnet. Off cause, the thickness of the spacing layer may be equal to the thickness of the magnet.

The present invention also provides a built-in sunshade product adapted for use in a double glazing comprising the above magnetic driving device. The magnetic driving device is capable of performing reliable operations such as opening and slat turning for the built-in sunshade product in the double glazing.

The present invention has the following advantages. Compared with the prior art, when a magnet used in the prior art and a magnet used in the present invention have the same size, the magnetic poles of the present invention are arranged so that the magnetic driving device of the present invention can provide a greater driving force while it can prevent the disadvantage that the slider and the operation handle easily fall from each other in use in the conventional device. As a result, the operation is more reliable.

### BRIEF DESCRIPTION OF THE DRAWINGS

FIGS. 1A and 1B are schematic views showing a configuration of a conventional double glazing with a blind;

FIG. 1C is a schematic side view of the blind in the conventional double glazing;

FIG. 2A is a schematic view showing a state of a handle and a slider of the conventional double glazing in which the handle and the slider attract each other to be attached on a glass without an external force applied to the handle;

FIG. 2B is a schematic view showing a state of the handle and the slider of the conventional double glazing in which the handle and the slider attract each other to be attached on the glass with a small external force F applied to the handle;

FIG. 2C is a schematic view showing a state of the handle and the slider of the conventional double glazing in which the handle and the slider attract each other to be attached on the glass with a large external force F applied to the handle;

FIG. 2D is a schematic view showing a state of the handle and the slider of the conventional double glazing in which the handle and the slider fall and magnetic transmission fails;

FIG. 3 is a schematic view showing a configuration of a magnetic driving device according to an embodiment of the present application;

FIG. 4A is a schematic view showing a state of a handle and a slider of the magnetic driving device according to the embodiment of the present invention in which the handle and the slider attract each other to be attached on a glass with a small external force F applied to the handle;

FIG. 4B is a schematic view showing a state of the handle and the slider of the magnetic device according to the embodiment of the present invention in which the handle and the slider attract each other to be attached on the glass with a large external force F applied to the handle;

FIG. 5A is a schematic front view showing a frame structure of the magnetic driving device according to the embodiment of the present invention;

FIG. 5B is a schematic sectional view of the frame structure of the magnetic driving device taken along line A-A of FIG. 5A;

FIG. 5C is a schematic perspective view showing the frame structure of the magnetic driving device;

FIG. 6A is a schematic view showing a built-in sunshade product for a double glazing according to an embodiment of the present invention; and

FIG. 6B is an enlarged schematic side view showing a magnetic driving device of the built-in sunshade product for a double glazing according to the embodiment of the present invention.

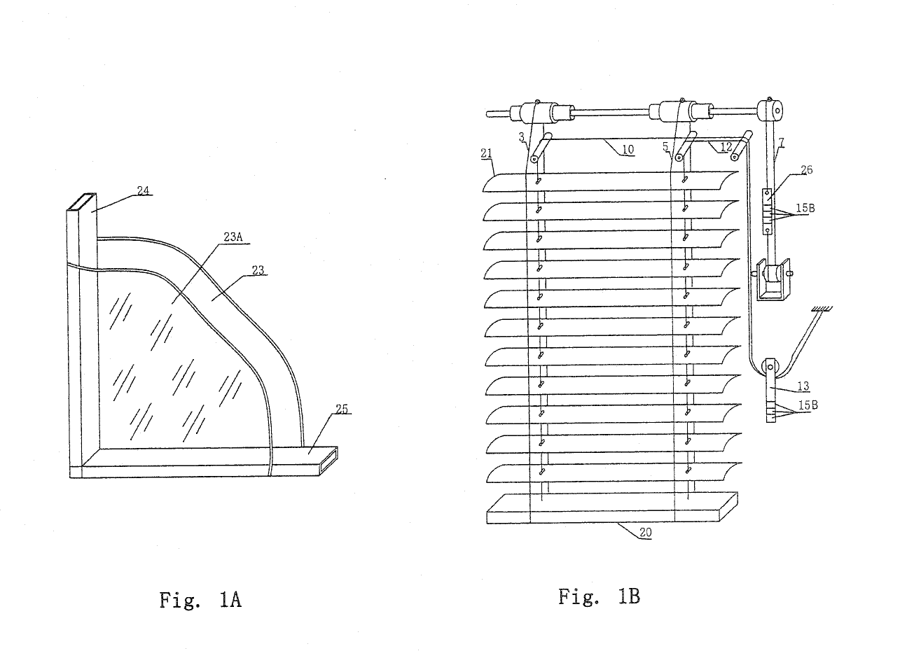

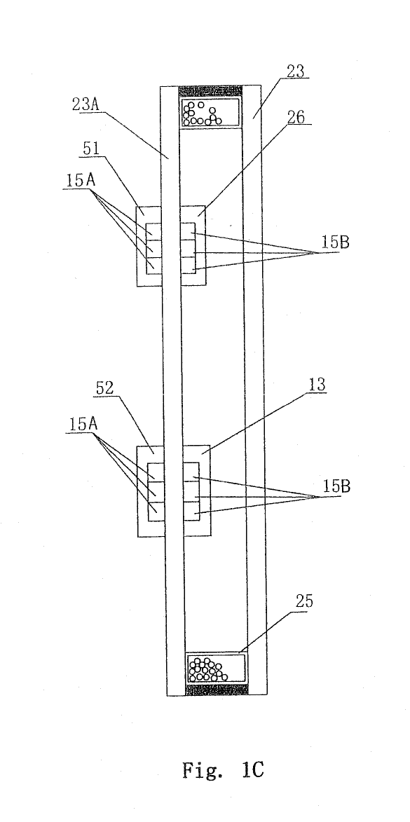

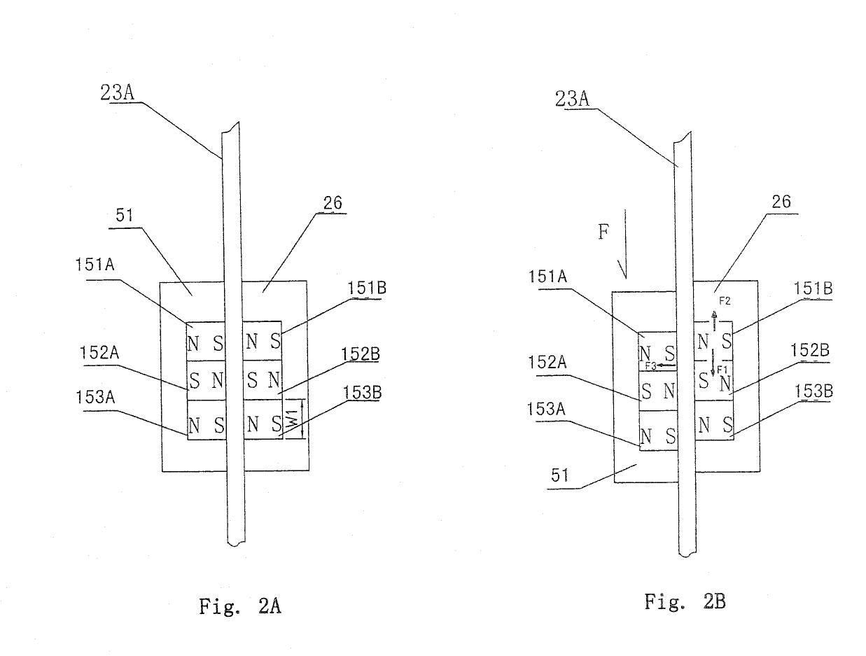

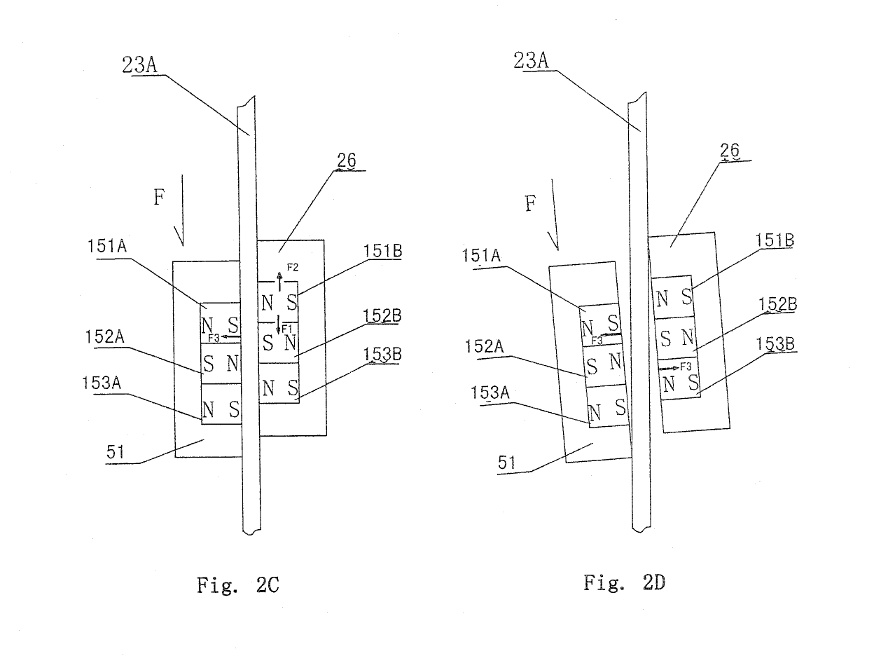

### DETAILED DESCRIPTION OF THE EMBODIMENTS

Embodiments of the present invention will be described hereinafter in detail with reference to the drawings. The present invention may, however, be embodied in many different forms and should not be construed as being limited to the embodiments set forth herein; rather, these embodiments are provided so that the present disclosure will be thorough and complete, and will fully convey the concept of the invention to those skilled in the art.

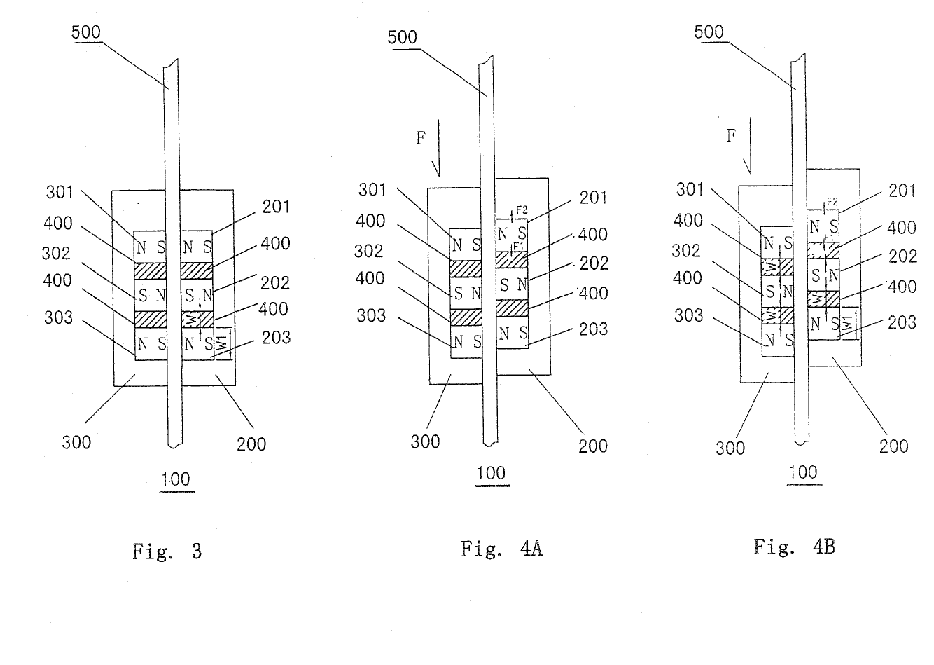

FIG. 3 is a schematic view showing a magnetic driving device according to an embodiment of the present application. In the state shown in FIG. 3, a handle 300 and a slider 200 attract each other to be attached on a glass 500 without an external force applied to the handle and the handle 300 and the slider 200 are substantially aligned with each other.

Referring to FIG. 3, the magnetic driving device 100 comprises the slider 200 located on an insider of the glass 500 and the handle 300 located on an outside of the glass.

Magnets 201, 202, and 203 are disposed in the slider 200. Polarities of magnetic poles of the magnet 202 are respectively opposite to polarities of magnetic poles of the magnets 201 and 203 adjacent to the magnet 202, and spacing layers 400 are disposed between the magnets 201 and 202, and between the magnets 202 and 203, respectively. The spacing layers are made of plastic material.

Magnet 301, 302, and 303 are disposed in the handle 300. Polarities of magnetic poles of the magnet 302 are respectively opposite to polarities of magnetic poles of the magnets 301 and 303 adjacent to the magnet 302, and spacing layers 400 are disposed between the magnets 301 and 302, and between the magnets 302 and 303, respectively. The spacing layers are made of plastic material.

Positions of the magnets 201, 202, and 203 and positions of the magnets 301, 302, and 303 correspond to each other one by one, and the polarities of the magnetic poles, which are towards the glass 500, of the magnets 201, 202, and 203 are opposite to the polarities of the magnetic poles, which are towards the glass 500, of the corresponding magnets 301, 302, and 303, respectively.

The spacing layer 400 has a thickness W. In the present embodiment, the thickness W of the spacing layer is equal to about 50% of a thickness W1 of the magnet.

FIG. 4A is a schematic view showing a state of the handle and the slider according to the embodiment of the present invention in which the handle and the slider attract each other to be attached on the glass with a small external force F applied to the handle. As shown in FIG. 4A, when the external force F applied to the handle is small, small relative offsets are formed between the magnets 301 and 201, between the magnets 302 and 202, and between the magnets 303 and 203, respectively. A driving force Fl parallel to the surface of the glass and oriented in a direction parallel to a direction of the external force is generated between the magnets 301 and 201, between the magnets 302 and 202, and between the magnets 303 and 203 by means of magnetic attraction. A resistance force F2 is generated accordingly. The offset magnets 301 and 302 partly face the spacing layers 400 of the plastic material respectively, while magnets 202 and 203 also partly face the spacing layers 400 of the plastic material respectively. Therefore, no repulsion force or a small repulsion force is generated. As a result, a resultant attractive force is not considerably reduced.

FIG. 4B is a schematic view showing a state of the handle and the slider according to the embodiment of the present invention in which the handle and the slider attract each other to be attached on the glass with a large external force F applied to the handle. As shown in FIG. 4B, when the slider is subjected to a sufficient resistance force F2 and the external force F is increased such that the handle 300 offsets from the slider 200 by half of the thickness W1 of the single magnet, it is found by test that the driving force F1 applied to the slider 200 by the handle 300 is not reduced, but reaches nearly a maximum. Furthermore, although the attractive force between the handle 300 and the slider 200 is reduced to about half of the attractive force generated in the initial state shown in FIG. 3, it is sufficient to ensure that the handle 300 and the slider 200 reliably attract each other to be attached on the glass and that fall of the slider and the handle does not occurs. Therefore, it is not difficult to appreciate that the magnet driving device is essentially changed by incorporating the spacing layer in the magnet driving device and can provide a reliable magnetic driving force.

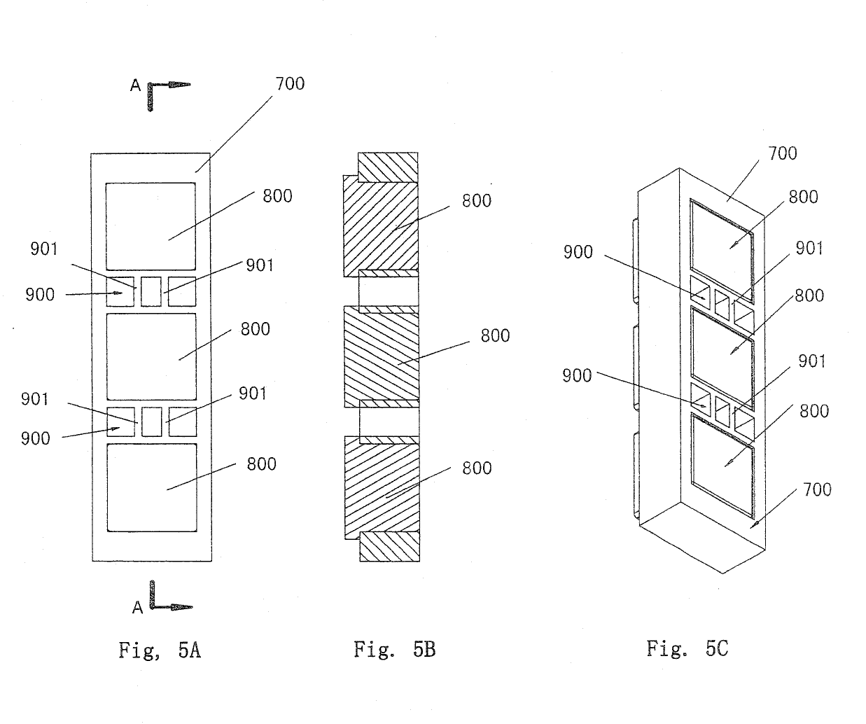

FIGS. 5A, 5B and 5C are a schematic front view, a schematic sectional view and a schematic perspective view showing a frame structure of a magnetic driving device according to the embodiment of the present invention, respectively. Referring to FIGS. 5A, 5B and 5C, the magnetic driving device comprises a frame 700 and three magnets 800. Spacing layers 900 are disposed between the magnets, respectively. Posts 901 are disposed in the spacing layers 900. Spaces between posts 900 are empty.

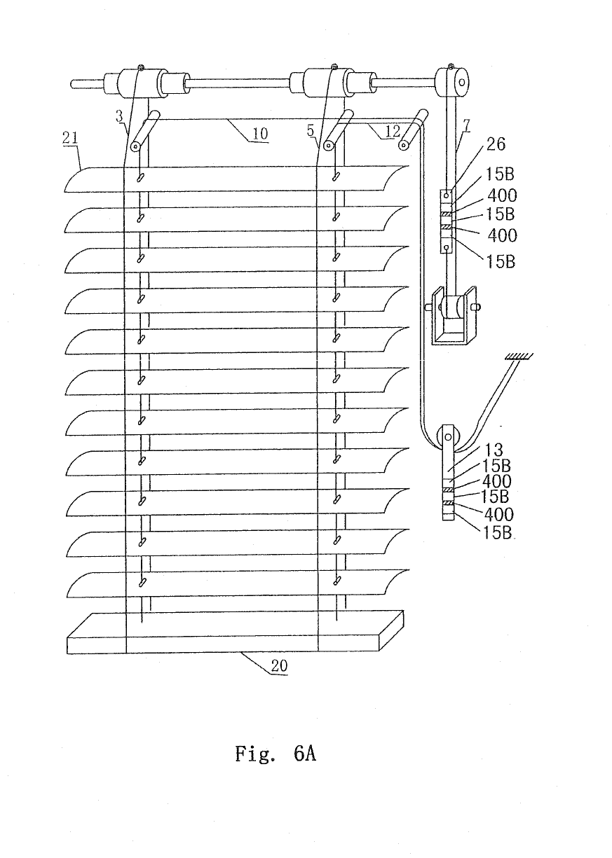

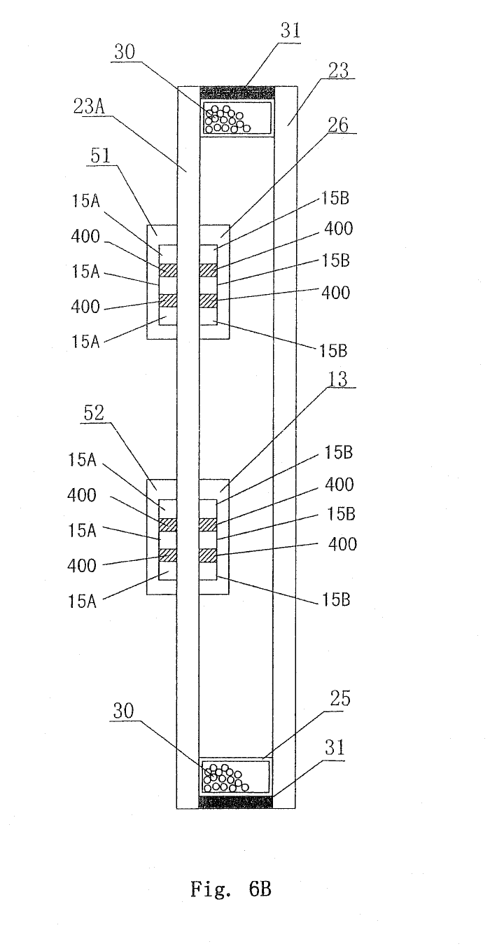

FIGS. 6A and 6B are schematic views showing a built-in sunshade product for a double glazing according to an embodiment of the present invention. Referring to FIGS. 6A and 6B, the spacing layers 400 are disposed between adjacent magnets 15A of a slat-turning operating handle 51 and an elevating operating handle 52 and between adjacent magnets 15B of a slat-turning slider 26 and an elevating slider 13. The material of the spacing layers is aluminum. A user can respectively operate the slat-turning operating handle 51 and the elevating operating handle 52 to move upwards and downwards. Although the magnets offset from each other, the offset only generates a driving force F1 without a repulsion force. Therefore, a slat-turning pull rope 7, or an elevating ropes 10 and 12 are conveniently driven to perform operations such as elevation, opening, and closing and the likes of a blind. Compared with the prior arts, when the size and the number of magnets used in the conventional magnetic driving device and the size and the number of magnets used in the magnetic driving device according to the embodiment of the present invention are respectively identical to each other, the built-in sunshade product for a double glazing according to the embodiment of the present invention can provide a greater driving force and a reliable magnetic drive.

The magnetic driving device according to the embodiment of the present invention is applicable to many fields. For example, when a place isolated by a glass is inconveniently entered or cannot be entered, a slider on an outside of the glass can be moved to control a slider disposed in the isolated place. The magnet driving device can perform simple works such as cleaning, and complicated works such as operation of a machine or equipment.

Although the embodiments of the present invention have been described and shown, it would be appreciated by those skilled in the art that many modifications, alterations and substitutions may be made in these embodiments without departing from the principles and spirit of the invention, the scope of which is defined in the claims and their equivalents.

1. A magnetic driving device comprising:
a slider disposed on an inside of a glass;
a handle disposed on an outside of the glass;
a plurality of magnets respectively disposed in the slider and the handle, the polarities of the adjacent magnetic poles of the magnets disposed in the slider being opposite to each other, the polarities of the adjacent magnetic poles of the magnets disposed in the handle, being opposite to each other; and
a spacing layer disposed between the adjacent magnets to space the adjacent magnets from each other; the spacing layer being made of a material that is not a magnet,
wherein positions of the magnets in the slider and positions of the magnets in the handle correspond to each other one by one, and the polarities of the magnetic poles, which are towards the glass, of the magnets in the slider are opposite to the polarities of the magnetic poles, which are towards the glass, of the corresponding magnets in the handle, respectively.

2. The magnetic driving device according to claim 1, wherein the spacing layer is made of plastic material, stainless steel, brass, aluminum, or iron.

3. The magnetic driving device according to claim 1, wherein the spacing layer is made of a single material, or a plurality of materials.

4. The magnetic driving device according to claim 1, wherein the spacing layer is formed in a frame structure with air in an intermediate portion of the frame structure.

5. The magnetic driving device according to claim 1, wherein the corresponding magnets in the handle and the slider have the same thickness and the spacing layers have the same thickness.

6. The magnetic driving device according to claim 1, wherein the spacing layer has a thickness less than or equal to a thickness of the magnet.

7. The magnetic driving device according to claim 1, wherein the spacing layer has a thickness equal to 30%-50% of a thickness of the magnet.

8. The magnetic driving device according to claim 1, wherein the spacing layer has a thickness larger than or equal to 2 mm.

9. A built-in sunshade product adapted for use in a double glazing comprising:
the magnetic driving device according to claim 1.
